(19) United States
(12) Patent Application Publication
(10) Pub. No.: US 2004/0069632 A1
(43) Pub. Date: Apr. 15, 2004

(54) Device and procedure to generate steady compound jets of immiscible liquids and micro/nanometric sized capsules

(76) Inventors: Antonio Barrero Ripoll, Sevilla (ES); Alfonso Ganan Calvo, Sevilla (ES); Raul Cortijo Bon, Malaga (ES); Ignacio Gonzalez Loscertales, Malaga (ES)

Correspondence Address: BRINKS HOFER GILSON & LIONE, P.O. BOX 10395, CHICAGO, IL, 60611, US

(21) Appl. No.: 10/631,496

(22) Filed: Jul. 31, 2003

(30) Foreign Application Priority Data
Jan. 31, 2002 (WO) PCT/ES02/00047
Jan. 31, 2001 (ES) 0100231

(51) Int. Cl. B01D 61/42

(52) U.S. Cl. 204/450; 204/600; 204/556

(57) ABSTRACT

A device and method for generating drops. The drops are generated by applying an electrical potential to a set of feeding tips which have immiscible or poorly miscible liquids running through them.

### OBJECT OF THE INVENTION

The object of the present invention is a procedure to generate electrified compound jets of several immiscible liquids with diameters ranging from a few tens of nanometers to hundred of microns as well as the relatively monodisperse aerosol of compound droplets resulting from the break up of the jets by varicose instabilities. An outer liquid enclosing an inner one (or several ones) is the typical structure of such droplets.

Liquids are injected at appropriate flow rates throughout metallic needles connected to high voltage supplies. The needles can be arranged either concentrically or one of them surrounding the others. Moreover, if the electrical conductivity of one or more liquid is sufficiently high, then the liquid can be charged through its bulk. In that case a non-metallic needle (i.e. silica tube) can be used to inject the liquid.

The device and procedure of the present invention are applicable to fields such as Material Science, Food Technology, Drug Delivery, etc. In fact, this procedure can be of interest in any field or technological application where the generation and control of compound jets of micro and nanometric size play an essential role of the process.

### STATE OF THE ART

In this invention, the electro hydrodynamic (EHD) forces are used to generate coaxial jets and to stretch them out to the desired sizes. For appropriate operating conditions, a liquid flow rate, in the form of a micro/nanometric-sized jet, is issued from the vertex of a Taylor cone. For appropriate operating conditions, a liquid flow rate, in the form of a micro/nanometric jet, is issued from the vertex of a Taylor cone. The break up of this jet gives rise to an aerosol of charged droplets, which is called electrospray. This configuration is widely known as electrospray in the cone-jet mode (M. Cloupeau and B. Prunet-Foch, J. Electrostatics, 22, 135-159, 1992). The scaling laws for the emitted current and the droplet size of the electrospray are given in the literature (J. Fernández de la Mora & I. G. Loscertales, J. Fluid Mech. 260, 155-184, 1994; A. M. Gañán-Calvo, J. Dávila & A. Barrero, J. Aerosol Sci., 28, 249-275, 1997, A. M. Gañán-Calvo, Phys. Rev. Lett. 79, 217-220, 1997; R. P. A. Hartman, D. J Brunner, D. M. A. Camelot, J. C. M. Marijnissen, & B. Scarlett, J. Aerosol Sci. 30. 823-849, 1999). Electrospray is a technique which has satisfactory proved its ability to generate steady liquid jets and monodisperse aerosols with sizes ranging from a few nanometers to hundred of microns (I. G. Loscertales & J. Fernández de laMora, J. Chem. Phys. 103, 5041-5060, 1995.). On the other hand, in all reported electrospray experiments, a unique liquid (or solution) forms the Taylor cone, except in the procedure described in the U.S. Pat. No. 5,122,670 patent (and sub-sequent patents: U.S. Pat. No. 4,977,785, U.S. Pat. No. 4,885,076, and U.S. Pat. No. 575,183). In the first patent, “Multilayer flow electrospray ion source using improved sheath liquid (1991)”, two or more miscible liquids are properly injected to be mixed in the Taylor cone to improve the transmission of ions, and the stability and sensitivity of a mass spectrometer.

The novelty of the present invention lies on the use of two or more immiscible liquids (or poorly miscible) to form, by means of EHD forces, a structured Taylor cone surrounded by a dielectric atmosphere (gas, liquid, or vacuum), see FIG. 1. An outer meniscus surrounding the inner ones forms the structure of the cone. A liquid thread is issued from the vertex of each one of the menisci in such a way that a compound jet of co-flowing liquids is eventually formed. The structured, highly charged micro/nanometric jet, which is issued from the vertex of the Taylor cone, breaks up eventually forming a spray of structured, highly charged, monodisperse micro/nanometric droplets. The term structured jet as used herein refers to either quasi-cylindrical coaxial jets or a jet surrounding the others. The outer diameter of the jet ranges from 50 microns to a few nanometers. The term spray of structured, highly charged, monodisperse, micro/nanometric droplets as used herein refers to charged droplets formed by concentric layers of different liquids or by an outer droplet of liquid surrounding smaller droplets of immiscible liquids (or emulsions). The outer diameter of the droplets ranges from 100 microns to a few of nanometers.

An advantage of the present invention lies on the fact that the resulting droplets have an uniform size, and that, depending of the properties of the liquids and the injected flow rates, such a size can be easily varied from tens of microns to a few nanometers.

Another advantage of this invention results from the fact that the jet break up gives rise to structured micro/nanometric droplets. In some particular applications, the outer liquid is a solution containing monomers, which under appropriate excitation polymerize to produce micro/nanometric capsules.

In those cases where uncharged droplets are required, the aerosol can be easily neutralized by corona discharge.

### DESCRIPTION OF THE INVENTION

The objects of the present invention are the procedure and the device to generate steady compound jets of immiscible liquids and capsules of micro and nanometric size.

The device consists of a number N of feeding tips of N liquids, such that a flow rate Qᵢ of the i-th liquid flows through the i-th feeding tip, where i is a value between 1 and N. The feeding tips are arranged concentrically and each feeding tip is connected to an electric potential Vᵢ with respect to a reference electrode. The i-th liquid that flows through the i-th feeding tip is immiscible or poorly miscible with liquids (i+1)-th and (i−1)-th. An electrified capillary structured meniscus with noticeable conical shape forms at the exit of the feeding tips. A steady capillary coaxial jet, formed by the N liquids, such that the i-th liquid surrounds the (i+1)-th liquid, issues from the cone apex. Furthermore, such capillary jet has a diameter ranging typically from 100 microns and 15 nanometers. This diameter is much smaller than the diameters of the feeding tips of the N liquids.

The feeding tips may be also arranged requiring that only the outer liquid surround the rest of the feeding tips. In this case, at the exit of the feeding tips, it is formed an electrified capillary meniscus with noticeable conical shape, whose apex issues an steady capillary compound jet formed by the N co-flowing liquids, in such a way that liquid 1 surrounds the rest of the liquids.

The N feeding tips of the device have diameters that may vary between 0.01 mm and 5 mm.

The flow rates of the liquids flowing through the feeding tips may vary between 10⁻¹⁷ m³/s and 10⁻⁷ m³/s.

When the distance between the feeding tip and the reference electrode is between 0.01 mm and 5 cm, the applied electric potential has to be between 10 V and 30 KV.

In the particular case in which N=2, the device object of the present invention comprises:

a) A feeding tip 1 through which liquid 1 flows at a flow rate Qᵢ and it is connected to an electric potential V₁.

b) A feeding tip 2 through which liquid 2 flows at a flow rate Q₂ and it is connected to an electric potential V₂.

Arranged such that the feeding tip 2 is surrounded by liquid 1 and such that V₁ and V₂ are differential values with respect to an electrode connected to a reference potential. Liquids 1 and 2 are immiscible or poorly miscible.

An electrified capillary meniscus with noticeable conical shape forms at the exit of the feeding tips. A steady capillary jet formed by liquids 1 and 2, such that liquid 1 completely surrounds liquid 2 issues from the cone apex. Such capillary jet has a diameter, which may be between 100 microns and 15 nanometers, which is smaller than the characteristic diameter of the electrified capillary liquid meniscus from which it is emitted.

The procedure object of the present invention will produce steady compound liquid jets and capsules of micro and nanometric size by flowing N flow rates Qᵢ of different liquids through each of the N feeding tips of the device previously described such that the i-th liquid which flows through the i-th feeding tip, surrounds the (i+1)-th feeding tip, and it is immiscible o poorly miscible with liquids (i−1)-th and (i+1)-th. At the exit of the feeding points it is formed an electrified capillary liquid meniscus with noticeable conical shape whose apex issues an steady capillary coaxial jet formed by the N liquids, such that the i-th liquid surrounds the (i+1)-th liquid. Such capillary jet has a diameter, which may be between 100 microns and 15 nanometers. This diameter is considerably smaller than the characteristic diameter of the electrified capillary liquid meniscus from which is emitted. Capsules whose size may vary between 100 microns and 15 nanometers are formed after spontaneous jet break up.

This procedure may be also realized but requiring that only the external liquid surrounds all the feeding tips. In that case, an electrified capillary liquid meniscus is formed, whose shape is noticeably conical, and from whose apex issues a steady capillary jet formed by the N co-flowing liquids, such that liquid 1 surrounds the rest of liquids.

Finally, they are also object of the present invention the multilayered capsules spontaneously formed after the break up of the capillary jet generated by the device and procedure here mentioned.

### BRIEF DESCRIPTION OF THE FIGURE

FIG. 1: Sketch of the device used to produce compound liquid jets of micro and nanometric size.

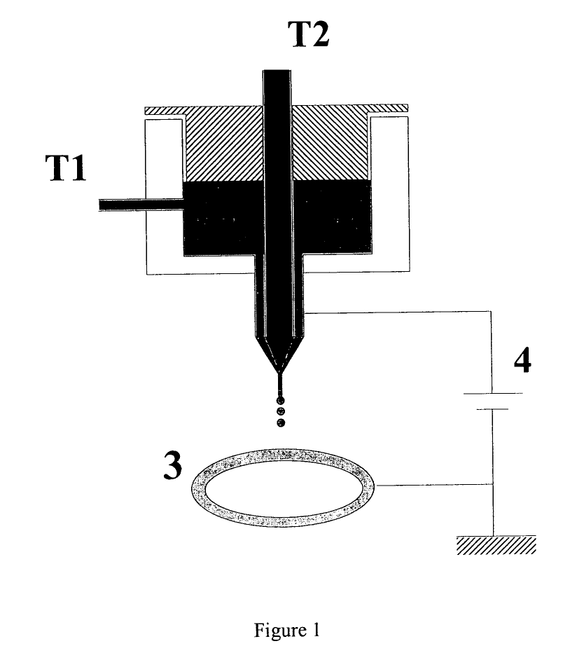

### DETAILED DESCRIPTION OF THE INVENTION

On the foregoing, we described two possible configurations that allow setting up a flow of two immiscible liquids that, by the unique action of the electro hydrodynamic (EHD) forces, results in the formation of a steady, structured, micro/nanometric sized capillary jet. This structured micro/nanometric sized capillary jet is immersed in a dielectric atmosphere (immiscible with the outermost liquid forming the jet) that might be a gas, a liquid or vacuum.

The basic device used in both configurations comprises: (1) a mean to feed a first liquid 1 through a metallic tube T₁, whose inner diameter ranges approximately between 1 and 0.4 mm, respectively; (2) a mean to feed a second liquid 2, immiscible with liquid 1, through a metallic tube T₂, whose outer diameter is smaller than the inner diameter of T₁. In this case, T₁ and T₂ are concentric. The end of the tubes does not need to be located at the same axial position; (3) a reference electrode, a metallic annulus for instance, placed in front of the needle exits at a distance between 0.01 and 50 mm; the axis of the hole of the annulus is aligned with the axis of T₁; (4) a high voltage power supply, with one pole connected to T₁ and the other pole connected to the reference electrode. T₁ and T₂ might not be connected to the same electric potential. All the elements are immersed in a dielectric atmosphere that might be a gas, a liquid immiscible with liquid 1, or vacuum. A part of the generated aerosol, or even the structured jet, may be extracted through the orifice in (3) to characterize it or to process it.

The EHD forces must act, at least, on one of the two liquids, although they may act on both. We term driver liquid the one upon which the EHD forces act to form the Taylor cone. In the first configuration, the driver liquid flows through the annular space left between T₁ and T₂, whereas in the second configuration the driver liquid flows through T₂, and the second liquid flows through the annular gap between T₁ and T₂. In any case, the electrical conductivity of the driver liquid must have a value sufficiently high to allow the formation of the Taylor cone.

Referring to the first configuration, when liquid 1 (the driver liquid) is injected at an appropriate flow rate Q₁ and an appropriate value of the electric potential difference is applied between T₁ and (3) and, liquid 1 develops a Taylor cone, whose apex issues a steady charged micro/nanometric jet (steady cone-jet mode). The characteristic conical shape of the liquid meniscus is due to a balance between the surface tension and the electric forces acting simultaneously and the meniscus surface. The liquid motion is caused by the electric tangential stress acting on the meniscus surface, pulling the liquid towards the tip of the Taylor cone. At some point, the mechanical equilibrium just described fails, so that the meniscus surface changes from conical to cylindrical. The reasons behind the equilibrium failure might be due, depending on the operation regime, to the kinetic energy of the liquid or to the finite value of the liquid electrical conductivity. The liquid thus ejected due to the EHD force, must be continuously made up for an appropriate injection of liquid through T₁ in order to achieve a steady state; let Q₁ be the flow rate fed to T₁. The stability of this precursor state may well be characterized by monitoring the electric current 1 transported by the jet and the aerosol collected at (3). Depending on the properties of liquid 1 and on Q₁, the liquid motion inside the Taylor cone may be dominated by viscosity, in which case, the liquid velocity everywhere inside the cone is mainly pointing towards the cone tip. Otherwise, the flow inside the cone may exhibit strong re-circulations, which must be avoided to produce structured micro/nanometric jets. Provided the flow is dominated by viscosity, one may then proceed to form the structured micro/nanometric jet. To do that, one must continuously supply liquid 2 through T₂. The meniscus of liquid 2, which develops inside the Taylor cone formed by liquid 1, is sucked towards the cone tip by the motion of liquid 1. Under certain operation conditions, which depend on the properties of both liquids (and on the liquid-liquid properties), the meniscus of liquid 2 may develop a conical tip from which a micro/nanometric jet is extracted by the motion of liquid 1. In this situation, there may exist regimes where the jet of liquid 2 flows coaxially with liquid 1. As before, liquid 2 must continuously be supplied to T₂ (say at a flow rate Q₂) in order to achieve a steady state.

When the device operates in the second configuration, the procedure is analogous, except that the motion of the driver liquid does not need to be dominated by viscosity.

Our experiments suggest that formation of coaxial liquid jets requires that the values of the surface tension of the different fluid pairs appearing in the problem satisfy the inequality σₐᵢ−σₐₒ>σₒᵢ, where σₐᵢ is the surface tension of liquid 2 and the dielectric atmosphere, σₐₒ is the surface tension of liquid 1 and the dielectric atmosphere, and σₒᵢ is the interfacial tension liquid 1-liquid 2, respectively.

To give an idea of the typical values of the different parameters appearing in the process, the next table collects experimental measurements of the electric current transported by the jet for different flow rates of the inner liquid keeping fixed the flow rate of the outer liquid.

Q₁ = 50 μl/min

| | | | | | | |
|---|---|---|---|---|---|---|
| (Q₂ (μl/min.) | 0.67 | 0.83 | 1.17 | 1.50 | 1.84 | 2.17 |
| I(μAmp.) | 1.1 | 1.3 | 1.5 | 1.7 | 1.9 | 2.0 |

Notice that in this example, corresponding to the case where Q₁ is much larger than Q₂, the value of the current 1 follows the well-known electrospray law

$$I ∝ {Q}_{2}^{1 / 2} .$$

To produce nanometric capsules through the procedure of the present invention a photopolymer may be used as external liquid. Indeed, the break up of the structured jet by the action of capillary instabilities gives place to the formation of an aerosol of structured droplets which, under the action of a source of ultraviolet light, allows to encapsulate the inner liquid.

1.- Device to produce steady compound multi-component liquid jets and micro and nanometric sized capsules, consisting of a number N of feeding tips of N liquids, such that the i-th liquid is injected at a flow rate Qᵢ through the i-th tip, where i varies between 1 and N. The feeding tips are arranged such that the (i−1)-th liquid surrounds the i-th tip, and each tip is connected to an electrical potential Vᵢ with respect to a reference electrode. The i-th liquid, which flows trough the i-th tip, is immiscible or poorly miscible with liquids (i+1)-th and (i−1)-th. An electrified capillary liquid meniscus with a noticeable conical shape forms at the feeding points exit in such a way that from the cone apex issues a steady capillary jet made up of the N liquids, such that the (i-1)-th liquid surrounds the i-th liquid, and such that the diameter of the capillary jet has a value between 100 microns and 15 nanometers which is much smaller than the characteristic diameter of the liquid meniscus from which the jet is emitted.

2.- Device to produce steady compound multicomponent liquid jets and micro and nanometric sized capsules, consisting of a number N of feeding tips of N liquids, such that the i-th liquid is injected at a flow rate Qᵢ through the i-th tip, where i varies between 1 and N. The feeding tips are arranged such that liquid 1 surrounds all the other feeding points. Liquid 1 is immiscible or poorly miscible with the rest of liquids. Each feeding point is connected to an electrical potential Vᵢ, where i varies from 1 to N, respect to a reference electrode. An electrified capillary liquid meniscus with a noticeable conical shape forms at the feeding points exit in such a way that from the cone apex issues a steady capillary jet made up of the N liquids, so that liquid 1 surrounds the rest of liquids, and such that the diameter of this capillary jet has a value between 100 microns and 15 nanometers which is much smaller than the characteristic diameter of the electrified liquid meniscus from which the jet is emitted.

3.- Device to produce steady compound multicomponent liquid jets and micro and nanometric sized capsules of claims 1 and 2, where the diameters of the N feeding tips have values between 0.01 mm and 5 mm.

4.- Device to produce steady compound multicomponent liquid jets and micro and nanometric sized capsules of claims 1-3, where the flow rate of the liquid flowing through the outermost feeding tip has a value between 10⁻¹⁷ m3/s and 10⁻⁷ m³/s, and where the flow rates of the liquids flowing through each of the other feeding tips have values between 10⁻¹⁷ m³/s and 10⁻⁷ M³/s.

5.- Device to produce steady compound multicomponent liquid jets and micro and nanometric sized capsules of claims 1-4, characterized such that for a separation between a feeding tip and the electrode of reference of a value between 0.01 mm and 5 cm, the applied electric potential has to be between 10 volts and 30 Kvolts.

6.- Device to produce steady compound bi-component liquid jet and micro and nanometric sized capsules of claims 1-5, where the number of feeding points N =2, comprising:
a) A first feeding tip I through which a liquid 1 flows at a rate Q₁ connected to an electric potential V₁.
b) A second feeding tip 2 through which a liquid 2 flows at a rate Q₂ connected to an electric potential V₂
such that the feeding tip 2 is surrounded by liquid 1, and the values of V₁ and V₂ are differential values with respect to a reference electrode connected to a reference potential, such that liquids 1 and 2 are immiscible or poorly miscible, forming at the exit of the feeding tips an electrified capillary liquid meniscus with a noticeable conical shape, whose apex issues an steady capillary jet formed by both liquids 1 and 2, such that liquid 1 completely surrounds liquid 2, and such that the diameter of the jet has a value between 100 microns and 15 nanometers which is smaller than the characteristic diameter of the electrified capillary liquid meniscus from which it is emitted.

7.- Procedure to generate steady compound multicomponent liquid jets and micro and nanometric sized capsules of claims 1, 3, 4 and 5, such that an i-th liquid at a flow rate Q_{i flows} through the i-th tip, where i varies between 1 and N, and each tip is connected to an electrical potential Vᵢ with respect to a reference electrode. The i-th liquid, which flows trough the i-th tip, is immiscible or poorly miscible with liquids (i+1)-th and (i−1)-th. An electrified capillary liquid meniscus with a noticeable conical shape forms at the feeding points exit in such a way that from the cone apex issues a steady capillary jet made up of the N liquids, such that the (i−1)-th liquid surrounds the i-th liquid, and such that the diameter of the capillary jet has a value between 100 microns and 15 nanometers which is much smaller than the characteristic diameter of the liquid meniscus from which the jet is emitted. The spontaneous break up of the jet thus forming capsules with diameters between 100 microns and 15 nanometers.

8.- Procedure to generate steady compound multicomponent liquid jets and micro and nanometric sized capsules of claims 2, 3, 4 and 5, such that an i-th liquid at a flow rate Q_{i flows} through the i-th tip, where i varies between 1 and N. The feeding tips are arranged such that liquid 1 surrounds all the other feeding points. Liquid 1 is immiscible or poorly miscible with the rest of liquids. Each feeding point is connected to an electrical potential Vᵢ, where i varies from 1 to N, respect to a reference electrode. An electrified capillary liquid meniscus with a noticeable conical shape forms at the feeding points exit in such a way that from the cone apex issues a steady capillary jet made up of the N liquids, so that liquid 1 surrounds the rest of liquids, and such that the diameter of this capillary jet has a value between 100 microns and 15 nanometers which is much smaller than the characteristic diameter of the electrified liquid meniscus from which the jet is emitted. The spontaneous break up of the jet thus forming capsules with diameters between 100 microns and 15 nanometers.

9.- Multicomponent and/or multilayered capsules with diameters comprised between 1000 microns and 15 nanometers, resulting from the break up of the jet generated by the procedures described in claims 7 and 8.
